(19) United States
(12) Patent Application Publication
(10) Pub. No.: US 2026/0120095 A1
(43) Pub. Date: Apr. 30, 2026

(54) SYSTEMS AND METHODS FOR ABSTRACTING USE OF BLOCKCHAINS

(71) Applicant: SmartContract Inc., New York, NY (US)

(72) Inventors: Michael Machado, New York, NY (US); David Kneisly, New York, NY (US); Ramiro Rinaudo, New York, NY (US); Lorenz Breidenbach, Zug (CH)

(73) Assignee: SmartContract Inc., New York, NY (US)

(21) Appl. No.: 19/369,092

(22) Filed: Oct. 24, 2025

Related U.S. Application Data
(60) Provisional application No. 63/711,880, filed on Oct. 25, 2024.
(60) Provisional application No. 63/874,539, filed on Sep. 2, 2025.

(51) Int. Cl. G06Q 20/38; G06F 16/22

(52) U.S. Cl. CPC G06Q 20/389; G06F 16/2255; G06Q 20/3825

(57) ABSTRACT

Systems, devices, and methods for blockchain abstraction are provided. Via use of the exemplary systems and methods, transactions between one or more blockchains and one or more off-chain systems are made faster and simpler.

### CROSS-REFERENCE TO RELATED APPLICATIONS

This application claims priority to and the benefit of: (i) U.S. Provisional Ser. No. 63/711,880 filed on Oct. 25, 2024 entitled “Blockchain Abstraction Layer,” and (ii) U.S. Provisional Ser. No. 63/874,539 filed on Sep. 2, 2025 entitled “Secure Runtime Environment for Blockchain Application Development and Deployment.” The foregoing applications are hereby incorporated by reference in their entirety for all purposes, including but not limited to those portions that specifically appear hereinafter, but except for any subject matter disclaimers or disavowals, and except to the extent that the incorporated material is inconsistent with the express disclosure herein, in which case the language in this disclosure shall control.

### TECHNICAL FIELD

This disclosure is in the field of distributed systems, and in particular the field of infrastructure for utilizing blockchain technology and distributed network computing.

### BACKGROUND

Prior approaches for processing data using a blockchain system have suffered from various limitations, for example limitations related to complexities with utilizing blockchains, and interoperability and efficiency of transfer of data or information across multiple blockchains. As the number of blockchains grows, people and applications are looking for ways to best make use of new chains and their features. There is a need for programs which allow more seamless transfer of digital assets and data across blockchains. Accordingly, systems and methods offering improvements thereto remain highly desirable.

### SUMMARY

In an exemplary embodiment, a blockchain abstraction layer device comprises: one or more processors configured by machine-readable instructions to: receive, by a mapping service of a blockchain abstraction layer node, an abstracted request from an institution; provide, by the mapping service, a user operation component based on the abstracted request to the institution; receive, by a bundler of the blockchain abstraction layer node, a user operation based on the user operation component from the institution; and execute an executed user operation based on the user operation onto a blockchain.

The one or more processors may be further configured by machine-readable instructions to map, by the mapping service, the abstracted request to determine the user operation component with a mapping table. The user operation may be signed by a private key infrastructure. The one or more processors may be further configured by machine-readable instructions to send, by the bundler, a return identifier to the institution, wherein the return identifier is based on the executed user operation. The one or more processors may be further configured by machine-readable instructions to submit, by the bundler, the user operation, to an entrypoint contract. The one or more processors may be further configured by machine-readable instructions to validate, by an institution BAL account, the user operation to result in a validated user operation. The one or more processors may be further configured by machine-readable instructions to listen, by a notification service, for the user operation executed to the blockchain; and notify, by the notification service, a user operation status change based on the executed user operation to the institution.

In an exemplary embodiment, a blockchain abstraction layer method comprises: sending, by a blockchain abstraction layer module associated with an institution, an abstracted request to a mapping service of a blockchain abstraction layer node; receiving, by the blockchain abstraction layer module, a user operation component from the mapping service based on the abstracted request; submitting, by the blockchain abstraction layer module, a signed user operation, wherein the signed user operation is based on the user operation component; sending, by a bundler associated of the blockchain abstraction layer node, the signed user operation to an entry point contract; and executing an executed user operation based on the signed user operation onto a blockchain.

The method may further comprise mapping, by the mapping service, the abstracted request to determine the user operation component with a mapping table. The signed user operation may be signed by a private key infrastructure. The method may further comprise sending, by the bundler, a return identifier to the institution, wherein the return identifier is based on the executed user operation. The method may further comprise submitting, by the bundler, the signed user operation, to an entrypoint contract. The method may further comprise validating, by an institution BAL account, the signed user operation to result in a validated user operation. The method may further comprise listening, by a notification service, for a user operation executed to the blockchain; and notifying, by the notification service, a user operation status change based on the executed user operation to the institution.

In an exemplary embodiment, a blockchain abstraction layer system comprises a processor; and a tangible, non-transitory memory configured to communicate with the processor, the tangible, non-transitory memory having instructions stored thereon that, in response to execution by the processor, cause the processor to perform operations comprising: sending, by a blockchain abstraction layer module associated with an institution, an abstracted request to a mapping service of a blockchain abstraction layer node; receiving, by the blockchain abstraction layer module, a user operation component from the mapping service based on the abstracted request; submitting, by the blockchain abstraction layer module, a signed user operation, wherein the signed user operation is based on the user operation component; sending, by a bundler associated of the blockchain abstraction layer node, the signed user operation to an entry point contract; and executing an executed user operation based on the signed user operation onto a blockchain.

In the blockchain abstraction layer, the processor may be further configured to perform operations comprising: mapping, by the mapping service, the abstracted request to determine the user operation component with a mapping table. The user operation may be signed by a private key infrastructure. The processor may be further configured to perform operations comprising: sending, by the bundler, a return identifier to the institution, wherein the return identifier is based on the executed user operation. submitting, by the bundler, the user operation, to an entrypoint contract. The processor may be further configured to perform operations comprising validating, by an institution BAL account, the user operation to result in a validated user operation.

The contents of this section are intended as a simplified introduction to the disclosure, and are not intended to limit the scope of any claim.

### BRIEF DESCRIPTION OF THE DRAWINGS

The accompanying drawings are included to provide a further understanding of the present disclosure and are incorporated in, and constitute a part of, this specification, illustrate various exemplary embodiments, and together with the description, serve to explain exemplary principles of the disclosure.

FIG. 1 illustrates a blockchain abstraction layer system, in accordance with various exemplary embodiments.

FIG. 2 illustrates operations in a blockchain abstraction layer system, in accordance with various exemplary embodiments.

FIG. 3A illustrates operational relationships in an exemplary blockchain abstraction system, in accordance with various exemplary embodiments.

FIG. 3B illustrates financial institution developer experience in an exemplary blockchain abstraction system, in accordance with various exemplary embodiments.

FIG. 3C illustrates multi-layer aspects of an exemplary blockchain abstraction system, in accordance with various exemplary embodiments.

FIG. 3D illustrates a software development architecture and operational flows therein in connection with an exemplary blockchain abstraction system, in accordance with various exemplary embodiments.

FIG. 4 illustrates operational and data flows in an exemplary use case for a blockchain abstraction system, in accordance with various exemplary embodiments.

FIG. 5 illustrates operational and data flows in an exemplary use case for a blockchain abstraction system, in accordance with various exemplary embodiments.

FIG. 6 illustrates operational and data flows in an exemplary use case for a blockchain abstraction system, in accordance with various exemplary embodiments.

FIG. 7 illustrates operational and data flows in an exemplary use case for a blockchain abstraction system, in accordance with various exemplary embodiments.

FIG. 8 illustrates operational and data flows in an exemplary use case for a blockchain abstraction system, in accordance with various exemplary embodiments.

### DETAILED DESCRIPTION

The detailed description of various exemplary embodiments herein makes reference to the accompanying drawings, which show various exemplary embodiments by way of illustration. While these various exemplary embodiments are described in sufficient detail to enable those skilled in the art to practice the disclosure, it should be understood that other embodiments may be realized and that structural, logical, and/or similar changes may be made without departing from the spirit and scope of the disclosure. Thus, the detailed description herein is presented for purposes of illustration and not of limitation.

For example, steps recited in any of the method or process descriptions may be executed in any suitable order and are not necessarily limited to the order presented. Furthermore, any reference to singular may include plural embodiments, and any reference to more than one component or step may include a singular embodiment or step.

As disclosed herein, exemplary embodiments provide a connection between legacy and on-chain systems, in both the legacy >on-chain and on-chain >legacy directions. In this manner, institutions can take advantage of the capabilities of blockchain technology without the complexity of interacting directly with various blockchain components.

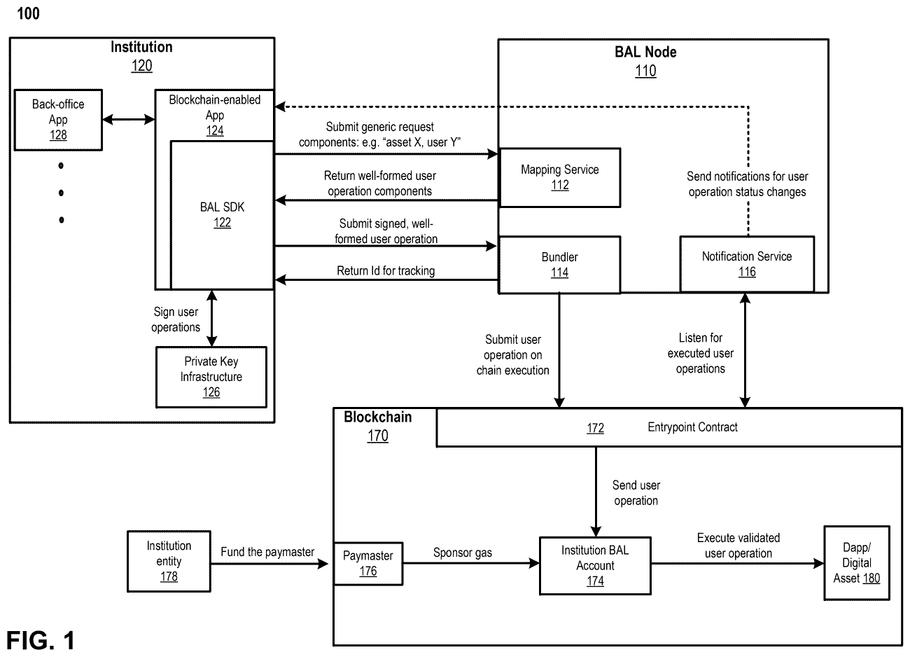

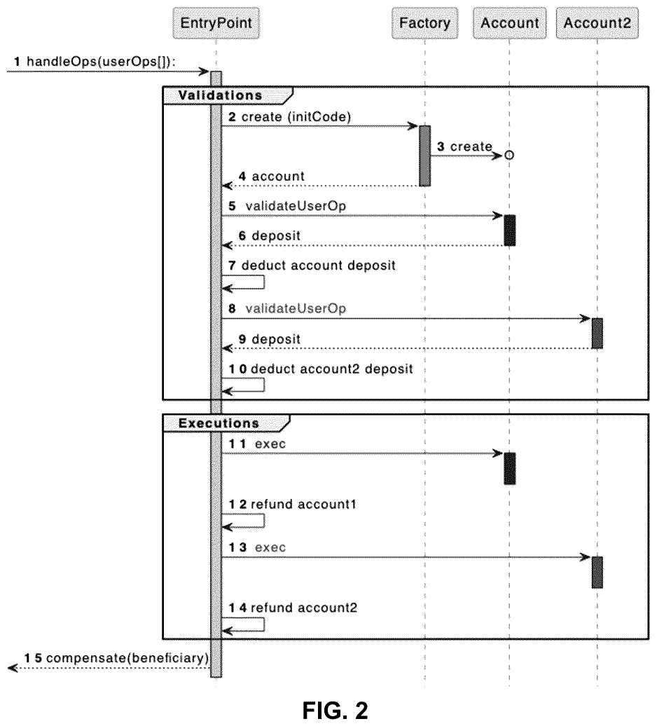

With reference now to FIGS. 1 and 2, in various a blockchain abstraction layer (BAL) system is operative to allow interaction between various systems and blockchains. For example, financial institutions are rapidly exploring the intersection of private blockchain applications and capital markets. Dedicated digital asset teams are being formed to address enterprise-grade infrastructure needs. However, a lack of clear regulations creates uncertainty for development. This hurdle is currently causing fragmented efforts as each player races to be the “first mover” in the blockchain space. To address this and other issues, exemplary principles of the present disclosure may be utilized to remove silos and connecting disjointed blockchain infrastructure while abstracting away the complexities of blockchain technology. Exemplary blockchain abstraction layer systems and principles as set forth herein allow institutions and financial institutions to focus on core functionalities without needing costly, extensive in-house blockchain expertise mitigating risk before the guarantees of finalized regulation. Stated another way, exemplary embodiments act as a bridge between systems to enable transactions.

In various exemplary embodiments, a BAL empowers any developer in an organization (for example, a bank, asset manager, FMI, or any other financial institution) to integrate existing application logic on blockchains, in order to participate in on-chain workflows for trading, settlement, payments, value transfers, information distribution and any other financial workflows-while not needing to know or use native blockchain primitives. Put simply, a BAL can serve as a gateway for traditional applications in an organization to read and write data from any smart contract on any chain (for example, selected by the BAL instance owner), and provide developer-friendly tooling.

Moreover, exemplary embodiments expand interoperable capabilities from cross-chains to off-chain onramps. These systems and methods can help simplify and help accelerate interactions between traditional systems and blockchain logic in smart contracts (for example, mapping, encapsulating complex workflows in simple “functions” to be invoked by web2 developers, and so forth).

Accordingly, in various exemplary embodiments, a blockchain abstraction layer (BAL) system may comprise a software development toolkit (SDK), also referred to as a BAL SDK. The BAL system may allow banking actors to set up and interact with blockchains through an abstracted layer. The BAL system may abstract away technicalities of using and transacting on the blockchain.

In various exemplary embodiments, the blockchain abstraction layer may remove silos by connecting disjointed blockchain infrastructure while abstracting away the complexities of blockchain. The blockchain abstraction layer may allow users, and institutions, such as financial institutions, to utilize core functionalities of blockchain technology without needing costly, extensive in-house blockchain expertise mitigating risk before the guarantees of finalized regulation. The blockchain abstraction layer systems may provide the benefit of greater efficiency through reduced transaction time, and faster settlement of trades and/or executions on the blockchain. Further, the blockchain abstraction layer system provides greater capital efficiency, and disintermediation through reduced need for intermediaries between users and blockchain transactions. Furthermore, the blockchain abstraction layer system provides the benefit of easier auditing and reporting, and reducing risk associated with blockchain transactions. Further, the blockchain abstraction layer systems provide new revenue opportunities, including new opportunities to generate yield, reach wider markets, and network effects.

In various exemplary embodiments, the BAL system allows users (such as banks, asset managers, financial market infrastructure or other financial institutions) to integrate existing application logic on blockchains, in order to participate in on-chain workflows for trading, settlement, payments, value transfers, information distribution and any other financial workflows—while not needing to know or use native blockchain primitives. In various exemplary embodiments, the BAL system comprises a gateway for users to read and write data from any smart contract on any chain (selected by the BAL instance owner). In various exemplary embodiments, the BAL system may work with cross chain interoperability protocols.

In various exemplary embodiments, blockchain abstraction layer systems, methods and devices are disclosed herein. In various exemplary embodiments, the blockchain abstraction layer may be configured to send and receive data between one or more blockchains and one or more non-blockchain systems.

In various exemplary embodiments, a blockchain abstraction layer system may provide the benefit of streamlining operations from users to the blockchain. For example, a BAL system may improve the speed and efficiency of interactions between developers and various blockchain networks. In various embodiments, a BAL system may comprise a mapping service and a bundler. Further, a BAL system may comprise a software development kit (SDK) configured to interact with the mapping service and bundler. For example, in various embodiments, a BAL system may integrate an EIP-4337 compatible bundler with a mapping service and a TypeScript-based software development kit (SDK) that enhances the view and permissionless NPM packages.

In various exemplary embodiments, a BAL system may comprise one or more software modules or components operative on one or more computing devices. The software modules may each be configured to address specific needs within the blockchain interaction framework and the BAL system.

In various exemplary embodiments, a BAL system may comprise and/or utilize smart contracts. The smart contracts may assist with validating and execution of user operations on-chain. The BAL system may comprise one or more smart contracts.

In various exemplary embodiments, the BAL system may comprise a bundle listener. The bundle listener may be configured to facilitate the simulation of incoming user operation requests, adding valid requests to a BAL queue. The bundle listener may provide inputs for fetching existing accounts and user operations. The bundle listener may provide developers methods to read arbitrary data from any blockchain contract on any supported network.

In various exemplary embodiments, a BAL system may comprise a bundler pipeline. The bundle pipeline may be configured to bundle user operations and send bundled user operations to the transaction manager.

In various exemplary embodiments, a BAL system may comprise a bundle tracker and notification service. The bundle tracker and notification service may be configured to track finalized user operations. The bundle tracker and notification service may be configured to notify stakeholders, for example through pre-configured callback URLs.

In various exemplary embodiments, a BAL system may comprise a mapping service. The mapping service may allow administrators to manage and populate mappings of blockchain contracts, tokens, and network data, ensuring that developers can easily retrieve and utilize this information.

In various exemplary embodiments, a BAL system may comprise a SDK extension. The SDK extension may be configured to improve existing view and permissionless NPM packages, providing developers with tooling to interact with a BAL node and its mapping service.

With reference now to FIG. 1, a blockchain abstraction layer system 100 is shown in accordance with various embodiments. The blockchain abstraction layer system 100 may comprise a BAL node 110 configured to send and receive data in connection with an institution 120 In various exemplary embodiments, BAL node 110 may be configured to receive user operations from the institution 120. The BAL node 110 may be configured to submit user operations based on the requests to the blockchain 170. The BAL node 110 may comprise a mapping service 112, bundler 114, a notification services 116 (also referred to as a listener). In various exemplary embodiments, a BAL node 110 may comprise a Chainlink node. However, any suitable node (comprising any suitable computing hardware and/or software) may be utilized, as desired.

In various exemplary embodiments, an institution 120 may utilize a BAL SDK 122. The BAL SDK 122 may enable developers or users to directly integrate or interface with the BAL node 110. For example, the BAL SDK 122 may interact with the BAL Node 110 in order to submit user operations onchain. The BAL SDK 112 (and/or software utilizing or created utilizing the same) may be configured to send signed user operations to a BAL node 114, wherein the BAL node 114 may transmit onchain without requiring gas. The BAL SDK 122 may also be referred to as a blockchain abstraction layer module.

In various exemplary embodiments, the BAL SDK 122 may send a generic request to the mapping service 112 of the BAL node 110. The generic request may also be referred to as an abstracted request. The generic request may comprise components including asset identifier, and/or user identifier.

In various exemplary embodiments, the BAL SDK 122 may be implemented using JavaScript or other suitable programming language or environment, for example TypeScript, Java Kotlin, Golang, or the like.

In various exemplary embodiments, a blockchain enabled app 124 may comprise an institution profile associated with the institution 120. For example, the institution profile may comprise call back information and signing keys associated with the private key infrastructure 126.

In various exemplary embodiments, the mapping service 112 may receive the generic request and map to onchain entities. The mapping service 112 may return to the BAL SDK 122, mapping results and/or user operation components. The mapping service 112 may comprise an API web layer. The mapping service 112 may receive a generic request from an institution 120. For example, the mapping service 112 may comprise mapping tables including user defined tables for mapping parameters used in requests received from institutions 120. For example, the API web layer for using the mapping services 112 may allow users to create mappings. The mapping service 112 provides mappings of common names to on-chain primitives, including networks, contract addresses, and contract APIs. The mapping service 112 may comprise Digital Token Identifier (DTIF) tables, Committee on Uniform Security Identification Procedures (CUSIP) tables, Ethereum Naming Service (ENS) domains tables, or other tables helpful for mapping the generic request to user operation components.

In various exemplary embodiments, the BAL SDK 122 may receive the mapping results and/or user operation components. The BAL SDK 122 may form a user operation based on the user operation components. For example, the BAL SDK 122 may form the user operation using the user operation components and other helpful information related to the user account or other information. In various exemplary embodiments, the BAL SDK 122 may call out to a key management service to sign user operations. The signed user operation may comprise a curl request or curl operation. For example, the signed user operation may comprise a script with parameters including the sender identifier, paymaster information, gas fee information, asset information, signature and other information.

In various embodiments, the BAL SDK 122 may sign the user operation utilizing a local private key infrastructure 126. The local private key infrastructure 126 may, in various exemplary embodiments, comprise a private key capable of verifying the user operation.

In various exemplary embodiments, the bundler 114 may receive the user operation from the BAL SDK 114. The bundler 114 may send a return identifier to the BAL SDK 112 for tracking. For example, the return identifier may comprise a hash, wherein the user identifier indicates that the user operation has been successfully submitted. The bundler 114 may process the user operation. The bundler 114 may submit the user operation for execution onchain. The bundler 114 may send the processed user operation to an entrypoint contract 172 associated with the blockchain 170.

In various exemplary embodiments, the blockchain 170 may comprise an entrypoint contract 172. The entrypoint contract 172 may be an EIP-4337 compatible contract or other suitable entrypoint contract. The entrypoint contract 172 may then send the user operation to an institution BAL account 174.

In various exemplary embodiments, the institution BAL account 174 may validate the user operation and execute the validated user operation onto a Dapp/digital asset 180. In various exemplary embodiments, the Dapp/digital asset 180 may comprise a decentralized application (Dapp) or other digital asset.

In various exemplary embodiments, an institution entity 178 may send funds to the paymaster 176. The paymaster 176 may sponsor gas to the institution BAL account 174 for each user operation that is executed. For example, the paymaster 176 may send gas to the institution BAL account 174 in the form of digital assets to power the execution of the Dapp/digital asset 180 onto the blockchain 170. Moreover, it will be appreciated that multiple possible implementations of a paymaster contract exist. For example, directing funding by an institution is one approach; alternative approaches include having a third party vendor fund the paymaster, or requiring that gas be paid by the BAL account holder.

In various exemplary embodiments, the notification service 116 may comprise a listener or BAL listener. The notification service 116 may enable an organization administrator to receive notification payloads at a callback URL, such that they can observe the state of a user operation as it is processed, transmitted, and eventually finalized on-chain without having to watch blockchain events. The notification service 116 may listen for executed user operations on a blockchain 170. The notification service 116 may also listen for executed user operations using an entrypoint contract 172 associated with a blockchain 170. The notification service 116 may then send notifications for user operation status changes to a blockchain enabled app 124 of the institution 120 in response to identifying an executed user operation. For example, the notification service 116 may create a log of the user operations successfully transmitted and then finalized by the bundler 114 to the blockchain 170.

In various exemplary embodiments, the notification service 116 may listen for onchain events, including executed user operations. The notification service 116 may convert the onchain events to notifications. In various exemplary embodiments, the notification service 116 may send notifications based on user operation status changes to a blockchain enabled app 124 which is running the BAL SDK 122. The notification service 116 may track the status of user operations. The notification service 116 may send notifications to the institution 120 of transaction finalizations, for example using predefined callback URLs.

In various exemplary embodiments, blockchain abstraction layer system 100 allows a blockchain enabled app 124 to use generic requests and execute user operations onchain. The blockchain enabled app 124 may provide services to other apps within the institution 120, such as back office app 128. For example, a Swift participant (or other financial messaging or payment platform), acting as or using financial messenger or payment processor within a fund management use case, operates a back office app 128 that leverages the BAL to query and invoke a smart contract-querying for open settlements and processing those requests upon successfully facilitating off-chain payment. In another example, a financial institution wanting to set the current Net Asset Value of a digital fund, operates a back office app 128 that invokes a contract on a daily basis via the BAL to update the NAV within the smart contract. In yet another example, a fund manager, managing multiple digital funds, interacts with various fund token contracts on a daily basis using the BAL to abstract away chain IDs and contract names. In general, back office app 128 may communicate with the blockchain enabled app 124, and thereby submit generic requests that are executed on the blockchain.

In various exemplary embodiments, BAL node 110 may further comprise a transaction manager (not shown). The transaction manager may assist with transaction flow of user operations execution on chain. For example, user operations may be queued, bundled, and submitted on-chain with direction of the transaction manager.

In various exemplary embodiments, the blockchain abstraction layer system 100 may comprise a middle layer of smart contracts to orchestrate the validation and execution of user operations on-chain. The smart contracts may be modified in how they interact with the blockchain 170. The smart contracts may operate on the blockchain 170 (i.e., “on-chain”or “onchain”).

In various exemplary embodiments, the smart contracts may comprise Account Abstraction (AA) contracts. The AA contracts may conform to Ethereum Improvement Proposal (EIP) 4337, which is a standard used in smart contracts for account abstraction, https://eips.ethereum.org/EIPS/eip-4337 (herein incorporated by reference, but except for any subject matter disclaimers or disavowals, and except to the extent in conflict with the express disclosure of this document, in which case this document shall prevail). In various exemplary embodiments, the entrypoint contract 172 may drive the flow of the AA contract. In various exemplary embodiments, the AA contract may communicate with the smart contract account (SCA). In various exemplary embodiments, the AA contract may also optionally communicate with the smart contract account factory, if the SCA needs to be deployed to validate the user operation. In various exemplary embodiments, the entrypoint contract 172 may contact the paymaster 176 to ensure funds (also referred to as gas) are available to sponsor the execution of the user operation. Given these checks passing, the entrypoint contract 172 executes the user operation via the smart contract account, and then bills the user on the paymaster.

As used herein, “AA Contracts” is a general term used to describe the collection of contracts involved in account abstraction: Entrypoint; Smart Contract Account Factory; Smart Contract Account Proxy; Smart Contract Account; Paymaster. It will be appreciated that in some embodiments, the system deploys a proxy contract that points to the BAL Account logic contract for each new account, thus making the deployment process less gas intensive.

In various exemplary embodiments, the Institution BAL Account 174 may be a Smart Contract Account (SCA). In various exemplary embodiments, the SCA receive and validate user operations. The SCA may use Elliptic Curve Digital Signature Algorithm (ECDSA) or other suitable Digital Signature Algorithm (DSA) to sign a validated user operation. In various exemplary embodiments, the Institution BAL Account 174 may be assigned a unique identifier and/or an owner address.

In various exemplary embodiments, the unique identifier can be used to identify a wallet against its end-customer. The owner may be the address of the signer for this Institution BAL Account 174 and has the authority to sign user operations that may be executed through this SCA. This owner entity is not necessarily the same as the customer. For example, the owner entity may be a banking admin that is signing off on behalf of customer transactions.

In various exemplary embodiments, the Institution BAL Account 174 may support the execution of a single transaction, as well as batched transactions on the digital asset 180 of the blockchain 170. For example, if a user wanted to interact with two different contracts at the same time (e.g., approve a token and then trade it on an exchange) they can do so through the BAL Account atomically. The Institution BAL Account 174 inherits the initializable interface and does not have a constructor, which makes it compatible with proxies. In various exemplary embodiments, each customer may have one or more Institution BAL Accounts 174.

In various exemplary embodiments, the blockchain abstraction layer system 100 may further comprise a smart contract factory (not shown). The smart contract factory may assist with reducing gas waste. The smart contract factory may also be referred to as a BAL account factory.

In various exemplary embodiments, the paymaster 176 may comprise a contract that maintains a list of signers. The Institution BAL Account 174 may determine if the signature of a user operation is generated by an approved signer, then the paymaster 176 may sponsor the user operation fully by providing gas to the Institution BAL Account 174. The paymaster 176 may desirably be “topped up” regularly, meaning that the institution entity 178 may desirably send funds to the paymaster 176 in order to provide gas to the Institution BAL Account 174 to execute the user operations.

In various exemplary embodiments, the blockchain abstraction layer system 100 may work with a cross chain interoperability protocol. For example, the blockchain abstraction layer system 100 may support transactions across multiple blockchains. In various exemplary embodiments, the blockchain abstraction layer system 100 may write data to the blockchain 170. In various exemplary embodiments, the blockchain abstraction layer system 100 may trigger off-chain transactions.

In various exemplary embodiments, the BAL node 110 may be deployed by an organization's internal network. In other exemplary embodiments, the BAL node 110 may be deployed on cloud infrastructure. However, BAL node 110 may be deployed on any suitable computing resources, as desired.

In various exemplary embodiments, the BAL SDK 122 may be configured to initiate a transaction on the blockchain 170. The BAL SDK 122 may initiate a request by providing the recipient address, transaction value (if applicable), and any necessary gas fees.

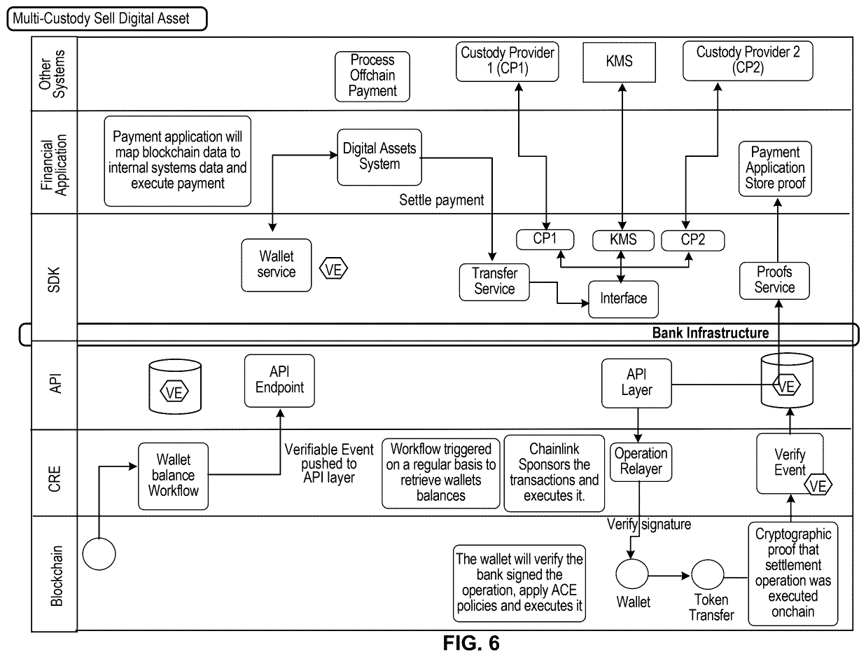

With reference now to FIGS. 6 through 10, in various exemplary embodiments a decentralized execution and compliance layer (“DECL” or “CRE Connect” system) provides a secure, programmable blockchain settlement capability, for example for financial institutions. Exemplary embodiments enable institutions to sign transactions using existing custody infrastructure (KMS, HSM, custody providers, and the like). Moreover, exemplary embodiments orchestrate financial blockchain workflows with verifiable event attestations and built-in policy enforcement. These embodiments support tokenization, stablecoin issuance, DvP, Transfer Agent and other financial workflows across blockchains. Moreover, exemplary embodiments eliminate the need for gas management, external smart contract development, or RPC infrastructure maintenance.

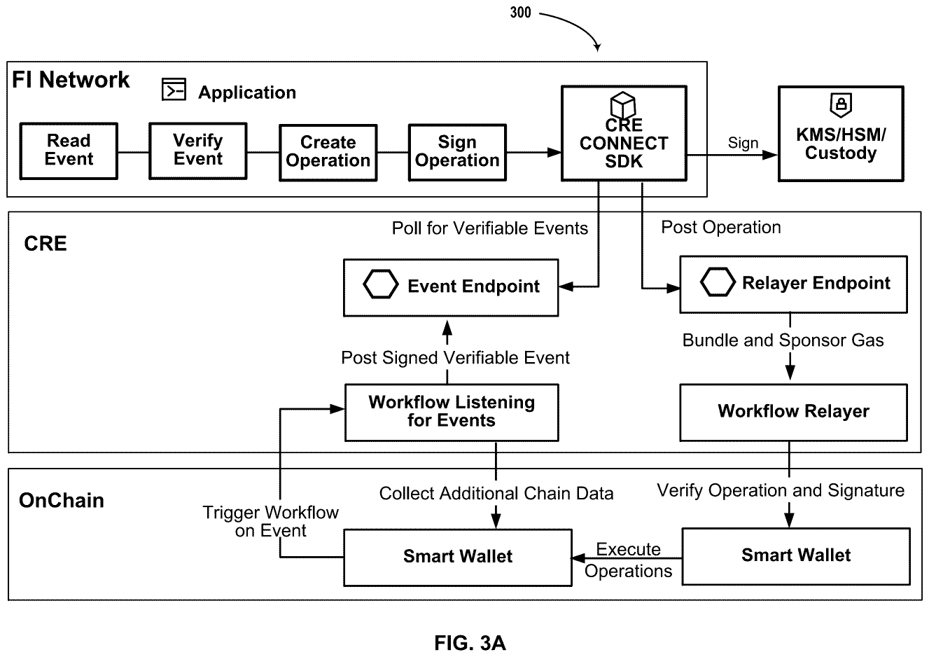

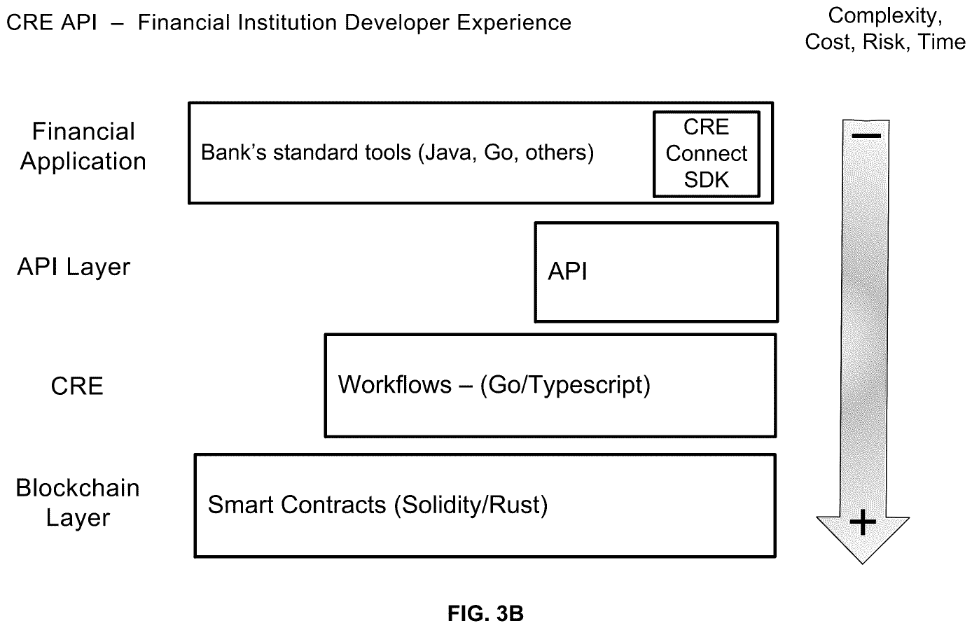

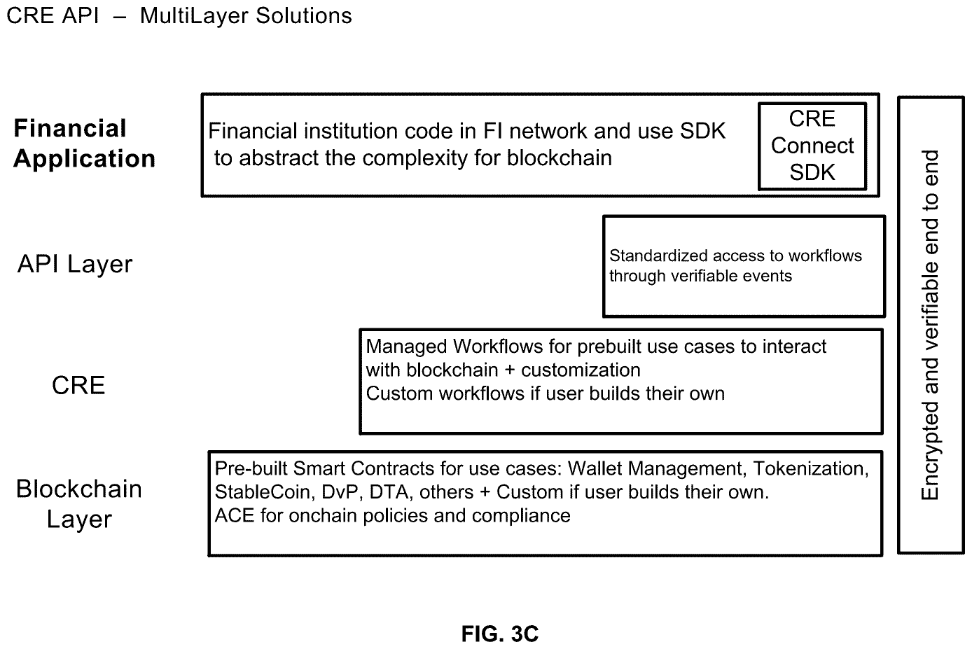

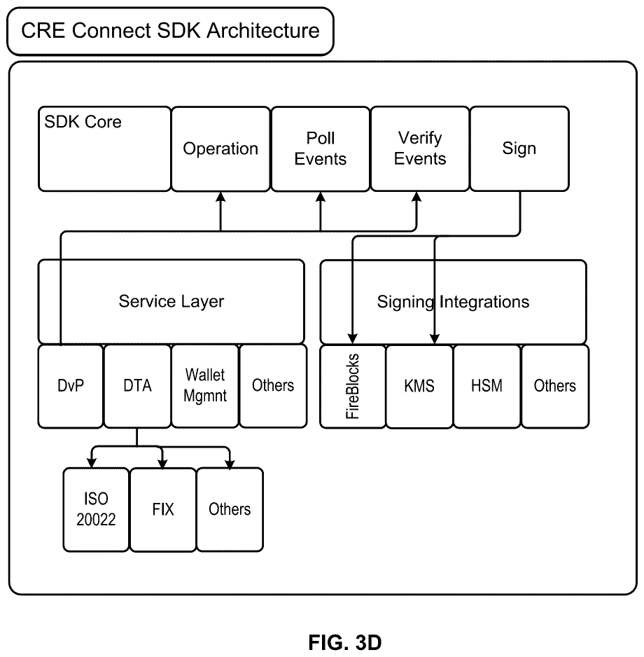

Turning to FIGS. 3A, 3B, 3C, and 3D an exemplary architecture for a blockchain abstraction/CRE Connect system 300 and associated SDK, and principles for use thereof, are shown. System 300 offers significant capabilities, including:
Universal asset access: the system can trigger flows involving native tokens, stablecoins, tokenized securities, NFTs, and permissioned assets across public blockchains.
Chain-agnostic execution: the system enables interaction with any blockchain through a single programmable interface.
Gasless experience: the system sponsors the gas across supported blockchains, meaning institutions do not need to hold or manage native tokens.
Prebuilt solutions: DvP, token issuance, transfers, and policy enforcement work across chains.
Decentralized validation per chain: CRE nodes pull data from multiple RPC endpoints per chain, achieving consensus before any action or attestation.
Reliability: built-in fault tolerance with multi-RPC redundancy and decentralized event verification-no single point of failure in transaction monitoring or execution.
Composable and future-proof: Add new chains or token standards as needed-no need to rewrite workflows, retool infrastructure, or adjust compliance logic.

Additionally, system 300 is configured to provide additional capabilities, including:
Non-custodial by design—all transaction signing occurs within institutional infrastructure—CRE Connect never holds, proxies, or exposes institutional private keys.
KMS/HSM compatible—supports integration with leading systems including AWS KMS, HashiCorp Vault, Azure Key Vault, Google Cloud KMS, Thales and others.
Abstracted signing interface with future-proof key types—system 300 SDKs and signing adapters connect institutional KMS, HSM or Custody solutions—no changes to key architecture required. Supports RSA and ECDSA, and ready for post-quantum approaches.
Multi-provider interoperability—can use multiple KMS, HSM or custody providers in parallel—enables isolating use cases (e.g., treasury vs tokenization) or managing multiple asset classes.
Policy-controlled signing—allows for combining internal institutional approval flows with Chainlink ACE policy engine to ensure regulatory and operational enforcement.
Audit-ready and tamper-proof-every transaction signed via institutional infrastructure is recorded and cryptographically signed as tamper-proof evidence it was delivered on-chain.
No smart contract rewrites required—system 300 signing logic integrates seamlessly with CRE Connect prebuilt workflows—tokenization, stablecoin minting, DvP, and so forth.

Yet further, system 300 enables capabilities including:
Multi-node event validation: All blockchain events (e.g., token transfers, settlement triggers, contract calls, and the like) are fetched and independently validated by a decentralized quorum of CRE nodes.
Cryptographic attestation: Each event is signed by the participating nodes, generating a verifiable proof that can be checked on-chain or off-chain.
Consensus-based trust: Institutions no longer rely on a single RPC or off-chain indexer—quorum signatures ensure the event reflects true chain state.
Tamper-proof audit trail: in system 300, every signed event includes metadata (block, tx hash, timestamp, validator signatures, etc.) and can be archived or embedded into existing compliance systems.
Pluggable into internal workflows: These signed verifiable events can trigger settlements, reconciliations, regulatory checks, or internal reporting flows.
Supports custom thresholds: system 300 policy logic can be configured to require 2 or more, majority, or full-node agreement before event validity is accepted.
Chain-agnostic: Works across supported chains without modifying existing logic.

Use of system 300 offers significant advantages for institutions, including:
No blockchain infrastructure to maintain—CRE Connect handles orchestration, signing flows, and blockchain interactions, eliminating the need to manage RPCs, indexers, or infrastructure internally.
No gas management required—system 300 sponsors gas across supported chains, removing the need to hold or rebalance native tokens.
Use of existing custody solution or KMS—no need for institution to onboard a new custody provider—reuse current secure signing infrastructure, reducing both integration and operational costs.
Prebuilt workflows=faster time to production. Avoid lengthy smart contract development cycles—launch tokenization, DvP, or stablecoin flows in days, not months.
Unified access to multi-chain assets. Exemplary embodiments reduce the cost and complexity of maintaining separate integrations per chain. A verifiable network abstracts multi-chain operations under one interface.
No new headcount required. Via use of exemplary embodiments, institutions can avoid the need for a specialized blockchain team. Rather, current developers can use their existing tools. System 300 handles reliability, execution logic, and compliance enforcement.
No vendor lock-in or proprietary traps. System 300 offers full interoperability with standard custody systems, open SDKs, and policy logic institutions control.

In various exemplary embodiments, system 300 may be implemented at least partially as a developer-accessible application programming interface (API) layer for a runtime environment (for example, an exemplary runtime environment disclosed in U.S. Provisional Ser. No. 63/874,539 filed on September 2, 2025). System 300 provides a secure and verifiable connectivity layer (API) to interact with an exemplary runtime environment to solve common blockchain integration needs. System 300 provides a simplified experience to consume pre-built workflows through verifiable events. In various exemplary embodiments, these verifiable events pack the power of consensus compute powered by Chainlink Decentralized Oracle Networks and CRE capabilities and workflows.

In system 300, Verifiable Events provide required data with the level of trust required by the most demanding customers that need to leverage consensus of a decentralized network to integrate systems in a trust minimized way and execute transactions or value movement.

For blockchain integration, system 300 allows developers and enterprises to monitor on-chain events across multiple chains in a standardized and trusted way. These Verifiable Events enable organizations to trigger business processes in their internal systems, react to smart contract events, and broadcast sponsored signed transactions, bridging the gap between Web2 and Web3 systems with cryptographic proofs and enterprise-ready interfaces.

In exemplary embodiments, in system 300 data integration, consensus computation validates the data (eg: CALM, market data, etc) and creates Verifiable Events that can be delivered and validated on-chain, but also consumed as a REST API. In some embodiments, system 300 implements advanced messaging patterns like publish/subscribe.

Accordingly, in various exemplary embodiments, system 300 is configured to address a set of common problems that come up when trying to work with public blockchains. System 300 users, such as financial institutions, desire to be able to effectively detect and trust these events on a blockchain, such as smart contract executions. These events should be able to trigger business processes in their existing internal systems (e.g., ERP, payment gateways). Once these business processes complete, customers need to deliver a response to the blockchain they are interacting with. System 300 provides these capabilities.

Financial institutions. Financial institutions have been switching their focus from internal private blockchains to leverage public blockchains tapping into additional liquidity and reach of public chains. This also has been reinforced by and as the financial institutions embark on this journey, often they lack the expertise and infrastructure to operate and interact with these blockchains. System 300 is positioned to address this need, without locking customers to a particular blockchain, and unlocking liquidity across all blockchains in the network.

Web3 Customers. Web3 customers have the need to react to events that happen on chain or multiple chains in a trust minimized way. While they are used to consuming these events through their smart contracts, they also have a strong need to perform off-chain logic (like rebalancing their crypto) across many public blockchains. The complexity of this if approached only as smart contracts on-chain logic is a big challenge, and enabling this logic off-chain is also daunting. Again, system 300 is configured to address this challenge.

In various exemplary embodiments, system 300 utilizes Verifiable Messaging to provide a communication layer (for example, Web2 Rest API, but any suitable layer may be used) to deliver Verifiable Events to allow system 300 users to consume from their existing systems, to trigger their internal processes.

As used herein, a “Verifiable Event” is an event with the data required by a customer to trigger their business process, collected and signed by a DON using a CRE capabilities or templated workflows. This approach provides the highest level of security, reliability with trust minimization, and in a way that is easy for system 300 users to self serve, and solve production “value securing” transactions across on and off chain.

In system 300, exemplary functionality of a Verifiable Messaging layer includes:
Reading Events from Blockchain
Relaying customer signed transactions (with gas sponsorship) to any blockchain in the network
Verifiable Data, enable customers to consume data feeds as Verifiable Events
CRE workflows for consensus computation, and consume it as a Verifiable Event
Advanced Messaging

In various exemplary embodiments, in system 300:

Blockchain Events: System 300 provides a simple way for customers to self-serve through a simple UI/API which are the events they would like to receive verifiable events by selecting which blockchain, contract and event. Upon registration, system 300 users see the URL to a REST API and get the public keys of the DON that will be signing their Verifiable Events. System 300 provides a simple client library and/or code snippets enabling customers to consume and verify these events easily using the technology stack of their choice. Customers can customize the underlying workflow that creates these Verifiable Events, allowing them to tailor those events to meet their particular needs.

Relaying Transactions to blockchains: System 300 allows customers to post signed transactions to any blockchain in the network and get them sponsored by (for example, by Chainlink), allowing them to quickly interact with any blockchain without all the complexity of dealing with tokens and gas from those chains. Customers sign their transactions using their KMS/Custody solution technology, and then send it to a system 300 API to relay the transactions on chain. Customers can pay for their transactions with their wallets or opt-in to get them sponsored (for example, by Chainlink). System 300 SDK enables customers to construct the transactions inside their current systems, allowing them to get transactions signed, and then a forwarder contract validates the transactions are signed by their keys.

Verifiable Data. In various exemplary embodiments, in system 300 an oracle network may be utilized as a provider of data into blockchains. However, other data providers may be utilized, as suitable. There is a growing demand for customers to consume these events on existing financial software in an easier way to get the value of decentralization without the complexity. Accordingly, system 300 users can leverage any existing Data Feed or create their own unique flavor where they can leverage an oracle network to provide them Verifiable Data through the Verifiable Messaging layer.

CRE Workflows. System 300 allows users to create in CRE their own workflows, create custom Verifiable Event leveraging an exemplary decentralized network, and consume it as an API through the Verifiable Messaging layer. This gives customers the ultimate flexibility of composing their verifiable events and delivering them on and off chain. Moreover, in some embodiments of system 300, individual capabilities may be exposed through an HTTP layer, which can be conceived as being a single step workflow that creates a Verifiable Event.

Advanced Messaging. In some exemplary embodiments, system 300 exposes the verifiable events as a REST API to make it easier to consume. However, in other exemplary embodiments, system 300 enables advanced messaging, whereby system 300 utilizes a message broker for these connections, allowing system 300 to provide more advanced systems integration patterns through the use of Verifiable Events, like Pub/Sub, scatter gather, guaranteed delivery, dead letter queue, and the like. For example, an event on Chain A can trigger multiple workflows that write to many other chains (data synchronization).

System 300 may be desirably used by entities such as:
Banking and Capital Markets Customers—System 300 provides a Blockchain substrate connectivity layer to blockchains, enabling them to seamlessly adopt public blockchains creating new market opportunities.
Fintechs—system 300 enables integrating tokenized asset flows with traditional infrastructure.
Web3 Devs & Protocols—system 300 allows them to outsource complex event/tx logic.
Security & Monitoring Platforms—can use system 300 to track and react to risky behavior.
Gaming & NFT Ecosystems—can use system 300 to respond to user actions across chains
Custody Solutions—can use system 300 to leverage verifiable events to increase trust and Tx relayer, to more chains.

In accordance with various exemplary embodiments, an example use case flow for system 300 for an off-chain payment is presented below, as described with respect to a fictional payment provider called “Paynet”:

1) A token exchange between 2 wallets on Ethereum through Chainlink DvP contract, triggers an event and locks/escrows the tokens. 2) CRE picks the event, creates a Verifiable Event. (Event signed by 16 decentralized nodes). 3) PayNet consumes the Verifiable Event through system 300 API and verifies the Event with the Public Keys of the Nodes through the SDK. 4) PayNet uses their existing system to trigger a transaction between their two customers to deliver the payment. 5) Upon successful payment, Paynet creates the settlement transaction using the SDK. 6) Paynet system then signs the transaction using the private keys of their wallet. 7) Paynet systems sends the signed transaction to system 300. 8) System 300 takes the transaction, sponsors the gas and delivers it on chain. 9) The Smart Contract Account verifies the transaction was signed by Paynet private key and executes the settlement on the DvP contract which then releases the tokens to the destination wallet.

It will be appreciated that the foregoing process has a compliance aspect: the DvP contract for Paynet can leverage a registry for the allowed wallets. Paynet can put an on-chain wallet on the registry when people register their wallets in their PayNet profiles. Then when the DVP is triggered, it would only take wallets that have been registered to PayNet, ensuring compliance.

In accordance with various exemplary embodiments, an example use case flow for system 300 for an on-chain settlement through stablecoins is presented below, again as described with respect to fictional payment provider Paynet:

1) User A sends a payment to User B on Paynet UI. 2) Paynet backend uses the system 300 SDK to post the transaction on-chain to lock the stable coin.3) User B accepts the payment in the Paynet UI. 4) Paynet backend uses the system 300 SDK to post the transaction on-chain to transfer the assets. 5) Paynet re-uses all their existing compliance checks and processes, but leverages blockchain for settlement. 6) CRE picks the transfer event, creates a Verifiable Event. (Event signed by 16 decentralized nodes). 7) PayNet consumes the Verifiable Event through system 300 API. 8) PayNet verifies the Verifiable Event with the Public Keys of the Nodes through system 300 SDK. 9) PayNet backend marks the transaction as settled. Similar comments regarding compliance are applicable to this example.

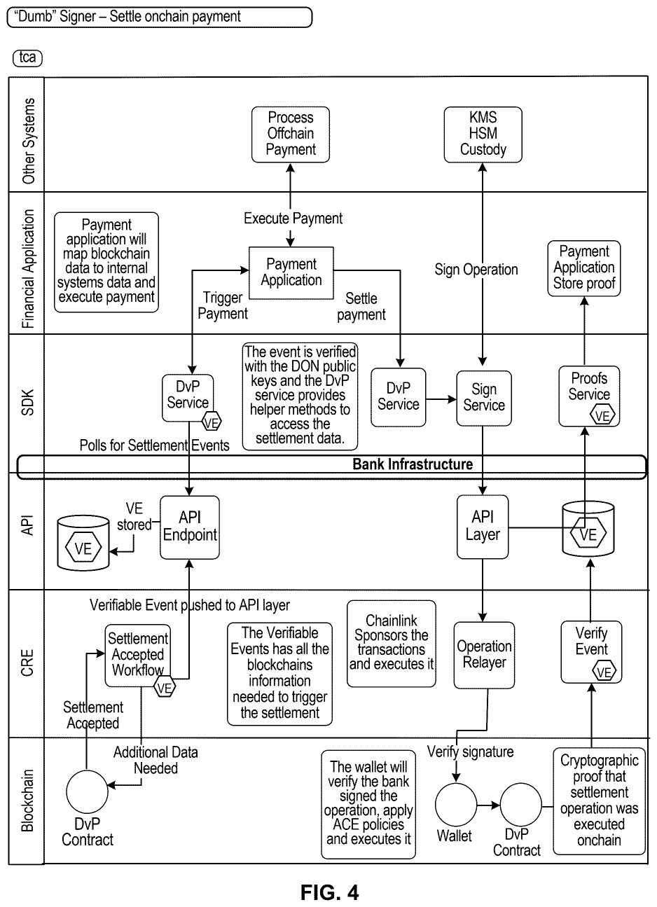

With reference now to FIG. 4, an exemplary use case for system 300 to enable settlement of an on-chain payment is shown.

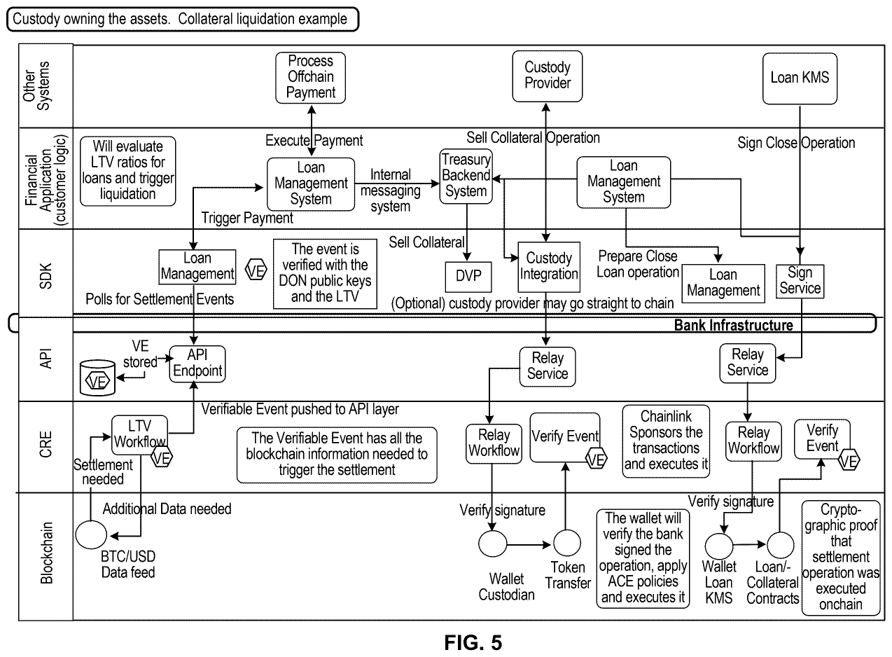

With reference to FIG. 5, an exemplary use case for system 300 in connection with liquidation of collateral is shown. Collateral liquidation from reading data feed from chain (this could also be consumed straight into the API, but using the example of a workflow reading the bitcoin price and using it to calculate LTV). SDK uses the loan management extensions to read the event and trigger the re-calculation of the LTV amounts for their loans. Customer logic: If a loan LTV amount is over the liquidation ratio, the loan system will trigger the trading backend to liquidate. Treasury backend uses the SDK to generate a sell operation of the asset, and instructs custody platform to sign the operation. (The custody platform might also relay the operation, but it would not generate a Verifiable Event in that case, so it is recommended the bank to use the custody platform to sign, and then system 300 relays the transaction to generate the proof). If the transaction is relayed by the custody solution, a custom CRE workflow may be utilized to create the verifiable event for this transaction. Once the digital asset is sold by the trading backend, it forwards the operation back to the loan management system, uses the load management extension to generate a transaction to return to the customer any excess from the liquidated assets back to the customer through the loan/collateral smart contract, following the same pattern, but in this case, they use the Loan HSM to sign for the operation.

With reference to FIG. 6, an exemplary use case for system 300 in connection with sale of a digital asset is shown. A financial institution is using multiple 3rd party custodians and self-custodied wallets to hold crypto assets across different public blockchains. Their portfolio management system decides to rebalance their portfolio, triggering selling multiple digital assets. The different assets are being held in different custodians, where each requires a different path to sell the assets. Customer application queries the different wallets balances used for custody and determine which are the assets that need to be sold across the different wallets. The application then triggers the transfer service for those amounts in those wallets. Depending on the type of wallet and custody solution used, the transfer uses the appropriate extension to translate (if needed) and sends the operation to each of the 3rd party custodians APIs or use KMS system to sign the hash of the operation with the private key of the wallet and relay the operation onchain. For the events forwarded by the relayer, Verifiable Events will be generated. For the custody based events, system 300 implements an additional API to request those events to generate the verifiable event of custody transactions.

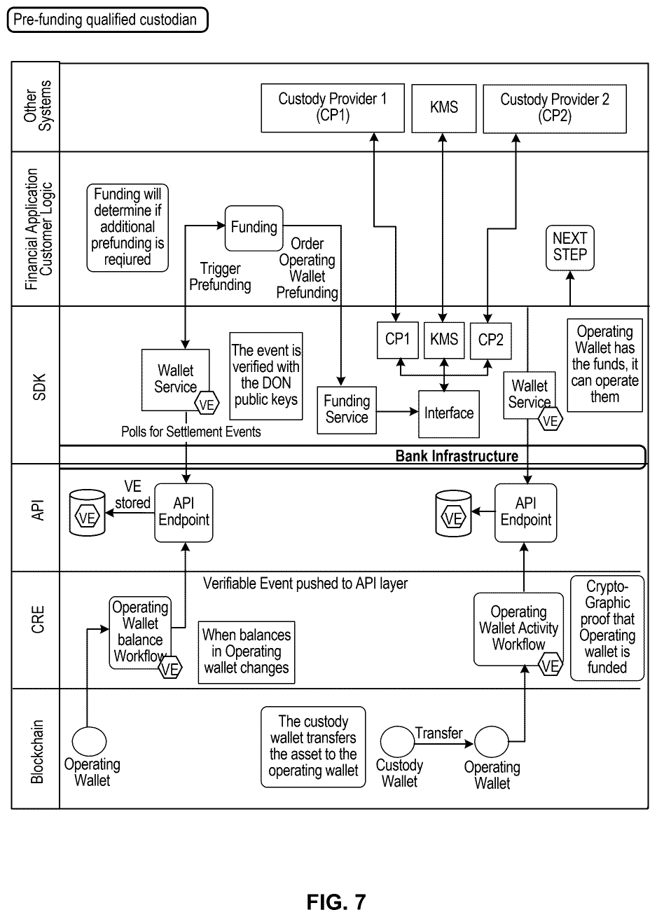

With reference to FIG. 7, an exemplary use case for system 300 in connection with pre-funding a qualified custodian is shown.

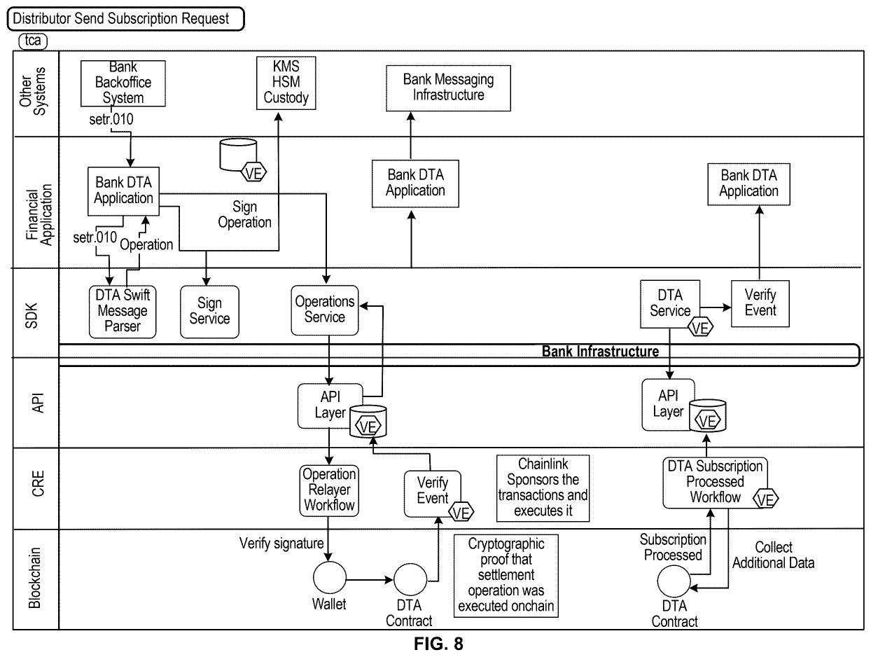

With reference to FIG. 8, an exemplary use case for system 300 in connection with a distributor send subscription request is shown.

Via use of system 300, institutions can interact with blockchain capabilities at a higher level of abstraction, simplifying the implementation of transactions across traditional paths as well as blockchains.

In addition to all the foregoing, principles of the present disclosure may be compatible with, complimentary to, and/or utilized in connection with principles set forth in:
U.S. Ser. No. 16/553,292 filed Aug. 28, 2019, entitled “Systems, Methods, and Storage Media for Interfacing At Least One Smart Contract Stored on A Decentralized Architecture With External Data Sources,”now U.S. Pat. No. 11,854,101;
U.S. Ser. No. 17/471,035 filed on Sep. 9, 2021, entitled “Computer Network Transaction Sequencing Method and System”;
U.S. Ser. No. 17/678,769 filed on Feb. 23, 2022, entitled “Method and Apparatus for Providing Secure Information to a Decentralized Computing Environment”;
U.S. Ser. No. 18/207,888 filed on Jun. 9, 2023, now U.S. Patent Application Publication No. 2023-031885 entitled “Method and Apparatus for Producing Verifiable Randomness Within a Decentralized Computing Network”;
PCT Application No. PCT/IB2025/057076 filed Jul. 12, 2025, and entitled “Cross-Chain Interoperability Protocol”;
PCT Application No. PCT/IB2025/057077 filed on Jul. 12, 2025, and entitled “Systems and Methods for Risk Management Networks”;
U.S. Provisional Ser. No. 63/867,897 filed on Aug. 21,2025 and entitled “Systems and Methods for Automated Compliance Enforcement”; and
U.S. Provisional Ser. No. 63/874,539 filed on Sep. 2, 2025, and entitled “Secure Runtime Environment for Blockchain Application Development and Deployment.”

The contents of each of the foregoing applications are incorporated herein by reference, but except for any subject matter disclaimers or disavowals, and except to the extent that the incorporated material is inconsistent with the express disclosure herein, in which case the language in this disclosure shall control.

For the sake of brevity, conventional database management, network communication, computer networking, data compression, error checking, and other aspects of exemplary systems and methods (and components thereof) may not be described in detail herein. Furthermore, the connecting lines shown in the various figures contained herein are intended to represent functional relationships and/or physical or communicative couplings between the various elements. It should be noted that many alternative or additional functional relationships or physical connections may be present in a practical system of consensus or related methods.

While the description references specific technologies, system architectures and data management techniques, practitioners will appreciate that this description is of various exemplary embodiments, and that other devices and/or methods may be implemented without departing from the scope of principles of the present disclosure.

While the steps outlined herein represent exemplary embodiments of principles of the present disclosure, practitioners will appreciate that there are many suitable computing algorithms and user interfaces that may be applied to create similar results. The steps are presented for the sake of explanation only and are not intended to limit the scope of the present disclosure in any way. Benefits, other advantages, and solutions to problems have been described herein with regard to specific embodiments. However, the benefits, advantages, solutions to problems, and any element(s) that may cause any benefit, advantage, or solution to occur or become more pronounced are not to be construed as critical, required, or essential features or elements of any or all of the claims.

Systems, methods, and computer program products are provided. In the detailed description herein, references to “various exemplary embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement principles of the disclosure in alternative embodiments.

For example, the steps recited in any of the method or process descriptions may be executed in any suitable order and are not limited to the order presented. Moreover, any of the functions or steps may be outsourced to or performed by one or more third parties. Modifications, additions, or omissions may be made to the systems, apparatuses, and methods described herein without departing from the scope of the disclosure. For example, the components of the systems and apparatuses may be integrated or separated. An individual component may be comprised of two or more smaller components that may provide a similar functionality as the individual component. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set. Furthermore, any reference to singular includes plural embodiments, and any reference to more than one component may include a singular embodiment. Use of ‘a’ or ‘an’ before a noun naming an object shall indicate that the phrase be construed to mean ‘one or more’ unless the context sufficiently indicates otherwise, as set forth in Slip op. at 8-9 (Fed. Cir. Oct. 19, 2023) (citing Baldwin Graphic Sys., Inc. v. Siebert, Inc., 512 F.3d 1338, 1342-43 (Fed. Cir. 2008)). For example, the description or claims may refer to a processor for convenience, but principles of the disclosure contemplate that the processor may be multiple processors. The multiple processors may handle separate tasks or combine to handle certain tasks. Although specific advantages have been enumerated herein, various exemplary embodiments may include some, none, or all of the enumerated advantages. A “processor” may include hardware that runs the computer program code. Specifically, the term ‘processor’ may be synonymous with terms like controller and computer and should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other devices.

It should be understood that the detailed description and specific examples, indicating exemplary embodiments, are given for purposes of illustration only and not as limitations. Many changes and modifications may be made without departing from the spirit thereof, and principles of the present disclosure include all such modifications. Corresponding structures, materials, acts, and equivalents of all elements are intended to include any structure, material, or acts for performing the functions in combination with other elements. Reference to an element in the singular is not intended to mean “one and only one” unless explicitly so stated, but rather “one or more.” Moreover, when a phrase similar to “at least one of A, B, or C” or “at least one of A, B, and C” is used in the claims or the specification, the phrase is intended to mean any of the following: (1) at least one of A; (2) at least one of B; (3) at least one of C; (4) at least one of A and at least one of B; (5) at least one of B and at least one of C; (6) at least one of A and at least one of C; or (7) at least one of A, at least one of B, and at least one of C.

What is claimed is:

1. A blockchain abstraction layer method, the method comprising:
sending, by a blockchain abstraction layer module associated with an institution, an abstracted request to a mapping service of a blockchain abstraction layer node;
receiving, by the blockchain abstraction layer module, a user operation component from the mapping service based on the abstracted request;
submitting, by the blockchain abstraction layer module, a signed user operation, wherein the signed user operation is based on the user operation component;
sending, by a bundler associated of the blockchain abstraction layer node, the signed user operation to an entry point contract; and
executing an executed user operation based on the signed user operation onto a blockchain.

2. The blockchain abstraction layer method of claim 1, further comprising:
mapping, by the mapping service, the abstracted request to determine the user operation component with a mapping table.

3. The blockchain abstraction layer method of claim 1, wherein the signed user operation is signed by a private key infrastructure.

4. The blockchain abstraction layer method of claim 1, further comprising:
sending, by the bundler, a return identifier to the institution, wherein the return identifier is based on the executed user operation.

5. The blockchain abstraction layer method of claim 1, further comprising:
submitting, by the bundler, the signed user operation, to an entrypoint contract.

6. The blockchain abstraction layer method of claim 1, further comprising:
validating, by an institution BAL account, the signed user operation to result in a validated user operation.

7. The blockchain abstraction layer method of claim 1, further comprising:
listening, by a notification service, for a user operation executed to the blockchain; and
notifying, by the notification service, a user operation status change based on the executed user operation to the institution.

8. A method of implementing a financial operation using a blockchain, the method comprising:
creating, by a financial institution, the financial operation to be implemented;
cryptographically signing, by the financial institution, the financial operation to form a signed financial operation;
transferring the signed financial operation to a software application operative on private computing hardware under the control of the financial institution;
posting, via an application programming interface, the signed financial operation to a relayer endpoint operative in a runtime environment external to the financial institution;
bundling, by the relayer endpoint, the signed financial operation and providing gas to execute the signed financial operation on the blockchain;
verifying the financial operation and signature;
executing the financial operation on the blockchain utilizing at least one smart wallet.

9. The method of claim 8, further comprising:
triggering, on completion of execution of the financial operation on the blockchain, a workflow event representing the executed financial operation; and
posting, to an event endpoint operative in the runtime environment, a signed verifiable event corresponding to the executed financial transaction.

10. The method of claim 9, further comprising polling, by the software application operative the private computing hardware, the event endpoint for the presence of the signed verifiable event.

11. The method of claim 10, further comprising updating, by the software application operative the private computing hardware and responsive to the presence of the signed verifiable event, internal records of the financial institution to reflect completion of the financial operation.
